(19) United States
(12) Patent Application Publication
(10) Pub. No.: US 2005/0281607 A1
(43) Pub. Date: Dec. 22, 2005

(54) Printer

(75) Inventor: Hisahiro Kato, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/155,761

(22) Filed: Jun. 20, 2005

(30) Foreign Application Priority Data
Jun. 18, 2004 (JP) 2004-181323

(51) Int. Cl. B41J 29/02; B41J 29/00

(52) U.S. Cl. 400/693

(57) ABSTRACT

In a printer comprising a paper container for containing a recording paper, the paper container has a base member mounted of a housing of the printer and a cover member rotatably pivoted on the base member via a pair of hinge structures. Each hinge structure has at least a first bearing portion formed on the cover member and having a first center hole, at least a second bearing portion formed on the base member and having a second center, a hinge pin inserted into the first center hole of the first bearing portion and the second center hole of the second bearing portion, a first and a second stoppers formed on the base member for facing both ends of the hinge pin with predetermined gaps. The second stopper has elasticity to be deformed when the hinge pin is inserted into the first and second center holes by applying a pressure thereto and to be recovered to a natural shape when the pressure is released so as to prevent escape of the hinge pin from the first and second center holes.

### BACKGROUND OF THE INVENTION

1. Field of the Invention

The present invention relates to a printer for forming an image on a paper sheet such as a thermal recording paper which is colored by heat.

2. Description of the Related Art

In a field of a printer forming an image on a paper sheet, a thermal recording paper which is colored by heat is conventionally used. In a printer using the thermal recording paper, the thermal recording paper is generally contained in an airtight paper container, since the thermal recording paper has a behavior easily be deteriorated by humidity. The paper container is generally comprised of a base member mounted on a housing of a printer and a cover member rotatably pivoted by a pair of hinges on the base member. The thermal recording paper is contained in an inner space formed by the base member and the cover member as a roll.

As for the hinges of the conventional paper container, a pair of bearing portions each having a horizontal center hole is formed on one of the base member or the cover member, a pair of or two pairs of bearing portions is or are formed on the other of the base member or the cover member, and a pair of hinge pins serving as rotation shafts of the hinge structures is provided for penetrating through the center holes of the bearing portions. For preventing the escape of the hinge pins from the center holes of the bearing portions, independent members such as E-shaped rings are used. The E-shaped ring, however, is generally difficult to be engaged with the hinge pins, since a working space between the base member and the cover member is narrower. In other words, the conventional hinge structure of the conventional paper container is designed regardless of the assemble workability.

With respect to the hinge structure of the container, Japanese Laid-Open Patent Application No. 2000-73643 shows that a hook with a guide slit and an engaging protrusion is integrally formed on an end of a hinge pin, and a flange engaged with the guide slit and engaging recesses engaged with the engaging protrusion are formed on an outer face in the vicinity of the hinge. When the hinge pin is inserted into center holes of bearing portions of the hinge, the guide slit is engaged with the flange and the engaging protrusion is engaged with one of the engaging recesses, so that it is possible to prevent the escape of the hinge pin.

Furthermore, Japanese Laid-Open Patent Application No. 5-59864 shows a hinge pin having a larger diameter portion adjoining to a portion to be inserted into center holes of bearing portions of a hinge, and a stopper is formed to be contacted with the larger diameter portion, so that it is possible to prevent the escape of the hinge pin.

### SUMMARY OF THE INVENTION

A purpose of the present invention is to provide a hinge structure of a container and a printer having the hinge structure of a paper container, by which the hinge can easily be assembled and the escape of the hinge pin can be prevented without using independent member such as an E-shaped ring.

A hinge structure of a container for rotatably pivoting a cover member on a base member in accordance with an aspect of the present invention comprises: at least a first bearing portion formed on the cover member and having a first center hole; at least a second bearing portion formed on the base member and having a second center hole of substantially the same diameter of the first center hole; a hinge pin inserted into the first center hole of the first bearing portion and the second center hole of the second bearing portion for aligning said at least a first bearing portion and said at least a second bearing portion on a same axis so that the cover member is rotatably pivoted on the base member; a first stopper formed at a first position on the base member or the cover member for facing an end of the hinge pin with a predetermined gap; and a second stopper formed at a second position on the base member or the cover member so that a part of the second stopper faces another end of the hinge pin with a predetermined gap in a natural shape, and having elasticity to be deformed when the hinge pin is inserted into the first center hole of the first bearing portion and the second center hole of the second bearing portion by applying a pressure thereto and to be recovered to the natural shape when the pressure is released so as to prevent escape of the hinge pin from the first center hole of the first bearing portion and the second center hole of the second bearing portion.

A printer in accordance with an aspect of the present invention comprises a paper container for containing a recording paper, a paper feeding mechanism for feeding the recording paper along a predetermined path, a recording head provided at a position facing the predetermined path and for forming an image on the recording paper, and a housing for containing the paper feeding mechanism and the recording head and on which the paper container is held. The paper container has a base member mounted on the housing and a cover member rotatably pivoted on the base member via an at least a hinge structure mentioned above.

By such configurations, when the hinge pin is once inserted into the first center hole of the first bearing portion and the second center hole of the second center hole, the first and second stoppers face both ends of the hinge pin with predetermined gaps. Since the hinge pin can move only in the gaps in axial direction thereof, it is possible to prevent the escape of the hinge pin from the first and second center holes.

It is possible that the second stopper serves as a plate spring integrally formed with the first member or the second member.

### BRIEF DESCRIPTION OF THE DRAWINGS

FIG. 1 is a perspective view showing a configuration of a printer in accordance with an embodiment of the present invention;

FIG. 2 is a perspective view showing a configuration of a paper container of the printer;

FIG. 3A is an enlarged perspective view showing a configuration of a department of a hinge of the paper container after insertion of a hinge pin;

FIG. 3B is an A-A sectional view of FIG. 3A;

FIG. 4A is an enlarged perspective view showing a configuration of the department of the hinge while the hinge pin is inserted to center holes of bearing portions of the hinge; and

FIG. 4B is an A-A sectional view of FIG. 4A.

### DETAILED DESCRIPTION OF THE EMBODIMENT

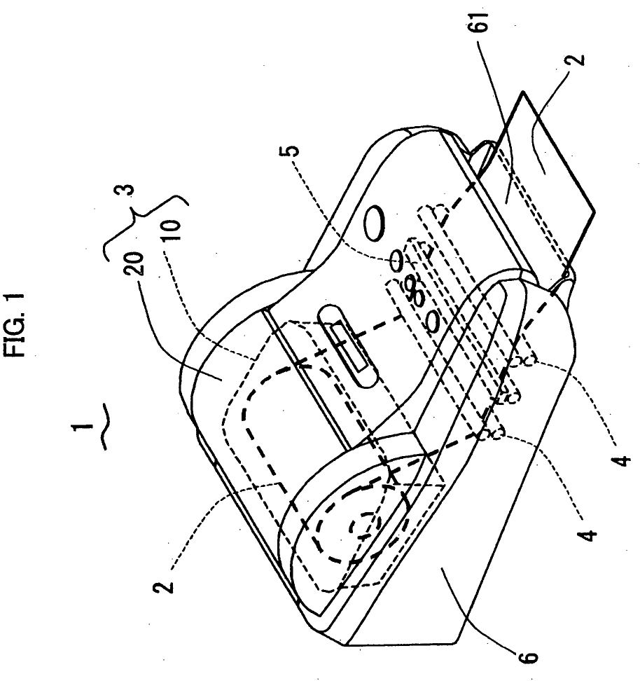

A hinge structure of a container and a printer using the same in accordance with an embodiment of the present invention are described with reference to the figures. FIG. 1 shows a configuration of a printer 1 in the embodiment. The printer 1 forms an image on a thermal recording paper 2 with using an image data inputted from, for example, a digital still camera or a personal computer.

The printer 1 comprises a paper container 3 for containing the thermal recording paper 2 as a roll, a paper feeding mechanism 4 for feeding the thermal recording paper 2, a thermal recording head 5 used for forming an image on the thermal recording paper 2 by applying heat selectively, and a housing 6 including the paper feeding mechanism 4 and the thermal head 5, and holding the paper container 3.

The thermal recording paper 2 is colored by heat, and wound around a tubular core as a roll. The paper container 3 comprises a base member 10 mounted on the housing 6 and a cover member 20 rotatably pivoted of the base member by a pair of hinge structures for opening and closing an inner space of the paper container 3. The roll of the thermal recording paper 2 is contained in the inner space of the paper container 3. A reel out mechanism (not shown) is further provided in the inside of the paper container 3 for reeling out an end portion of the roll of the thermal recording paper 2 to the paper feeding mechanism 4 provided in an inside of the housing 6. The paper feeding mechanism 4 reciprocally moves the thermal recording paper 2 in longitudinal direction thereof with respect to the thermal recording head 5 for forming a color image on the thermal recording paper 2. The thermal recording head 5 has an array of minute heat generating devices arranged in a width direction of the thermal recording paper 2 (or a direction perpendicular to the feeding direction of the thermal recording paper 2). The minute heat generating devices are controlled for heating or not heating with using an image data inputted from a digital still camera or a personal computer.

The printer 1 further comprises a cutter (not shown) for cutting the thermal recording paper 2 by a predetermined length, which is provided at a position downstream side of the thermal recording head 5 in a feeding path of the paper feeding mechanism 4. The paper feeding mechanism 4 further carries the cut paper sheet of the thermal recording paper on which an image is formed from an opening 61 of the housing 6. In such a printer 1, it is possible to print an image with a photographic frame such as a normal frame, a panorama frame, and so on.

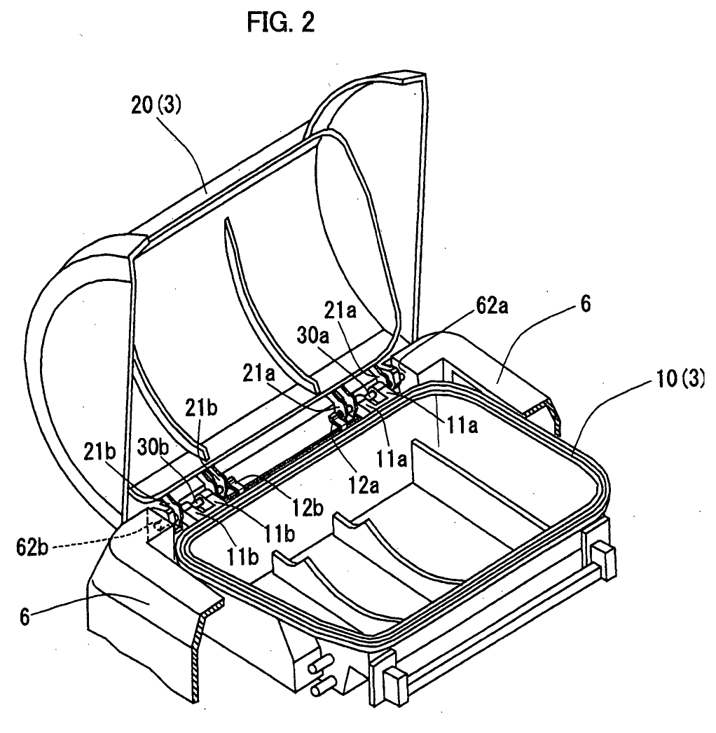

FIG. 2 shows a configuration of the paper container 3. In FIG. 2, illustration of the roll of the thermal recording paper 2 and the reel out mechanism of the thermal recording paper 2 is omitted. As mentioned above, the paper container 3 comprises the base member 10 and the cover member 20 rotatably pivoted on the base member 10 by the hinges. The base member 10 is fixed on the housing 6 by, for example, screws. The cover member 20 is coupled with the base member 10 via hinge pins 30a and 30b so that the cover member 20 is, rotatably pivoted on the cover member 10.

The base member 10 has two pairs of bearing portions 11a and 11b each having a center hole to which the hinge pins 30a and 30b are inserted, and a pair of stoppers 12a and 12b used for preventing escape of the hinge pins 30a and 30b from the center holes of the bearing portions 11a and 11b. On the other hand, the cover member 20 has four pairs of bearing portions 21a and 21b to which the hinge pins 30a and 30b are inserted. The housing 6 has a pair of stoppers 62a and 62b facing an end of the hinge pins 30a and 30b for preventing the escape of the hinge pins 30a and 30b from the center holes of the bearing portions 11a, 11b, 21a and 21b.

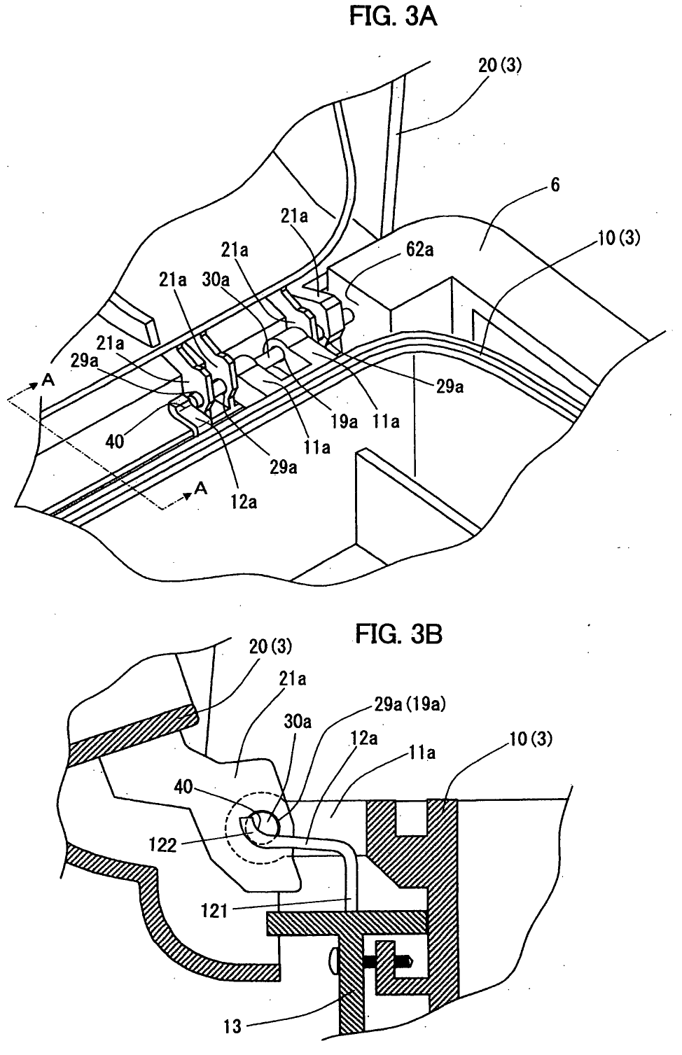

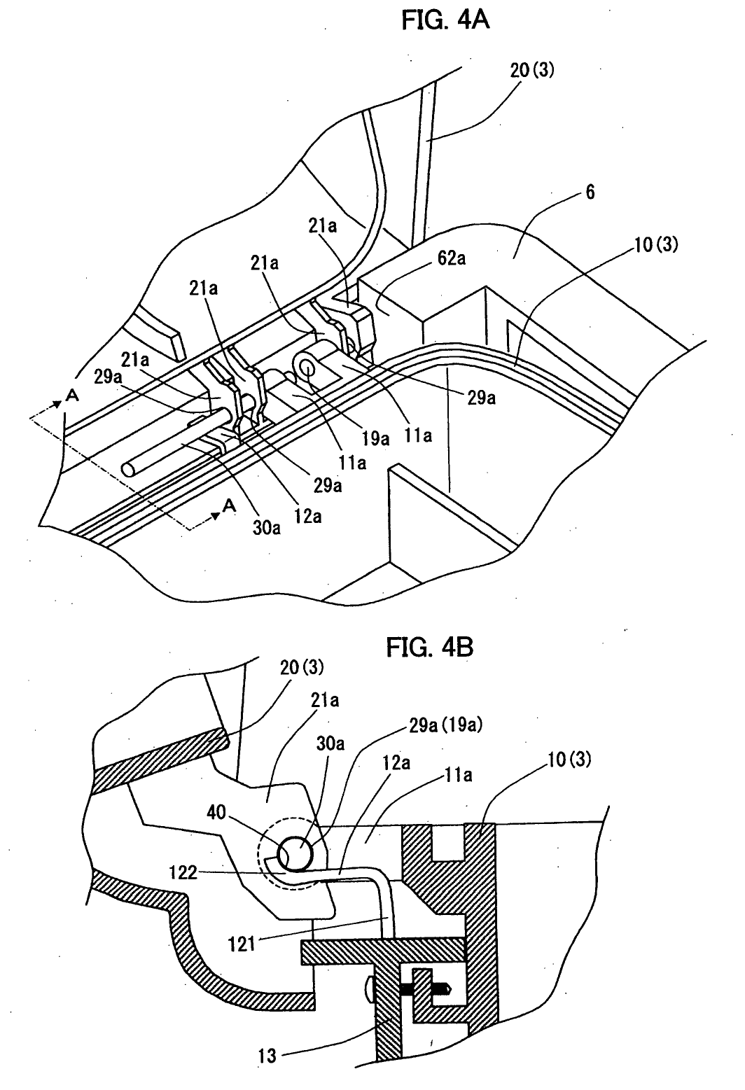

Detailed configuration of the hinges of the paper container 3 is described with reference to FIGS. 3A, 3B, 4A and 4B. The bearing portions 11a (and 11b not shown in these figures) are integrally formed with the base member 10 by resin molding. Each bearing portion 11a (or 11b) has a horizontal center hole 19a to which the bearing pin 30a or 30b is inserted. Similarly, the bearing portions 21a (and 21b) are integrally formed with the cover member 20 by resin molding. Each bearing portion 21a (or 21b) has a horizontal center hole 29a to which the bearing pin 30a (or 30b) is inserted. The hinge pins 30a (and 30b) are cylindrical and made of, for example, a metal material such as a stainless steel. A diameter of the hinge pins 30a (and 30b) is a little smaller than the diameter of the center holes 19a and 29a of the bearing portions 11a (and 11b) and 21a (and 21b). A length of the hinge pins 30a (and 30b) is a little shorter than a distance between the stoppers 12a and the 62a (and 12b and 62b).

The stoppers 12a (and 12b) are fixed on the base member 10 via a holder 13. The stoppers 12a (and 12b) have a substantially L-shaped section as a natural shape, made of an elastic material such as a resin so that a rear anchor 121 is integrally formed with the holder 13 and a portion near to the front end 122 serves as a plate spring or a cantilever. As shown in FIG. 3B, when no external force is applied to the stopper 12a (or 12b), the front end 122 of the stopper 12a (or 12b) is located at a natural position overlapping the center holes 19a of the bearing portion 11a (or 11b) in the vertical direction by elasticity of the material of the stopper 12a (or 12b).

FIGS. 3A and 3B show a state that the hinge pin 30a (or 30b) is fully inserted into the center holes 19a and 29a of the bearing portions 11a (or 11b) and 21a (or 21b). When the hinge pin 30a (or 30b) is fully inserted into the center holes 19a and 29a of the bearing portions 11a (or 11b) and 21a (or 21b), the stopper 12a (or 12b) takes the natural shape, so that the front end 122 is located for facing an end of the hinge pin 30a (or 30b) in an axial direction of the hinge pin 30a (or 30b). Thus, the position of the hinge pin 30a (or 30b) is restricted between the stoppers 12a and 62a (or 12b and 62b). Even when an external force is applied to the hinge pin 30a (or 30b) in the axial direction thereof, the motion of the hinge pin 30a (or 30b) is restricted in a gaps between both ends of the hinge pin 30a (or 30b) and the stoppers 12a and 62a by contacting with the stopper 12a or 62a (or 12b or 62b). Thus, the escape of the hinge pin 30a (or 30b) can be prevented.

FIGS. 4A and 4B shows a state that the hinge pin 30a (or 30b) is in mid-way to be inserted into or pulled out from the center holes 19a and 29a of the bearing portions 11a (or 11b) and 21a (or 21b). A circularly bent guide face 40, on which the hinge pins 30a (and 30b) can be disposed, is formed at the front end 122 of the stoppers 12a (and 12b), and the front end 122 of the stoppers 12a (and 12b) can be warped by the elasticity in a plane perpendicular to the center axis of the hinge pins 30a (and 30b). Thus, the hinge pins 30a (and 30b) can be inserted into or pulled out from the center holes 19a and 29a of the bearing portions 11a and 21a (and 11b and 21b) while the front end 122 of the stoppers 12a (and 12b) are warped to be lower than the center holes 19a and 29a in the vertical direction, as shown in FIGS. 4A and 4B.

Assembling of the paper container 3 is described. First, the base member 10 is fixed on the housing 6 by screws. Subsequently, the cover member 20 is held that the center holes 29a of the bearing portions 21a (and 21b) of the cover member 20 coincide with the center holes 19a of the bearing portions 11a (and 11b) of the base member 10. Under such a state, the hinge pin 30a (or 30b) is disposed on the guide face 40 of the stopper 12a (or 12b) with a pressure for warping the front end. 122 of the stopper 12a (or 12b). The hinge pin 30a (or 30b) is further pushed in the axial direction thereof toward the center holes 19a and 29a of the bearing portions 11a and 21a (or 11b and 21b). When the center axis of the hinge pin 30a (or 30b) coincides with the axis of the center holes 19a and 29a of the bearing portions 11a and 21a (or 11b and 21b), the hinge pin 30a (or 30b) proceeds into the center holes 19a and 29a of the bearing portions 11a and 21a (or 11b and 21b). When the hinge pin 30a (or 30b) is completely inserted into the center holes 19a and 29a of the bearing portions 11a and 21a (or 11b and 21b), the hinge pin 30a (or 30b) detaches from the guide face 40 of the stopper 12a (or 12b), and the pressure for warping the front end 122 of the stopper 12a (or 12b) is released. Thus, the front end 122 of the stopper 12a (or 12b) returns to the natural position, so that the escape of the hinge pin 30a (or 30b) can be prevented. The other hinge pin 30b (or 30a) is inserted into the center holes 19a and 29a of the bearing portions 11b and 21b (or 11a and 21a) in the same manner. Consequently, the paper container 3 can be assembled.

In the assembled paper container 3, the cover member 20 is rotatably pivoted around the hinge pins 30a and 30b on the base member 10 by a pair of hinges which are comprised of the hinge pins 30a and 30b, and bearing portions 11a, 11b, 21a and 21b. Furthermore, the escape of the hinge pin 30a or 30b is prevented by the stoppers 12a and 62a or 12b and 62b.

For disassembling the paper container 3, the stoppers 12a and 12b are forcible warped so that the front end 122 of the stoppers 12a and 12b is located below the center hole 19a and 29a of the bearing portions 11a, 11b, 21a and 21b by applying a pressure, and the hinge pins 30a and 30b are pulled out from the center hole 19a and 29a of the bearing portions 11a, 11b, 21a and 21b. Simultaneously, the cover member 20 is disengaged from the base member 10. After that, the base member 10 is removed from the housing 6. Since the stoppers 12a and 12b has elasticity, it is possible to repeat the assembling and disassembling of the paper container 3.

According to the above-mentioned hinge structure and the printer 1 using the same, the hinge pins 30a and 30b can easily be inserted into the center holes 19a and 29a of the bearing portions 11a, 11b, 21a and 21b while the front ends 122 of the stoppers 12a and 12b are warped by applying pressures thereto. Furthermore, when the pressure applied to the stoppers 12a and 12b are released, the escape of the hinge pins 30a and 30b can easily be prevented by recovering of the stoppers 12a and 12b. Similarly, the hinge pins 30a and 30b can easily be pulled out from the center holes 19a and 29a of the bearing portions 11a, 11b, 21a a and 21b while the front ends 122 of the stoppers 12a and 12b are warped by applying pressures thereto. Still furthermore, since the circularly bent guide face 40 is formed at the front end 122 of the stoppers 12a and 12b, the hinge pins 30a and 30b can easily be held on the guide face 40 while the assembling and disassembling of the paper container 3. Thus, the assembling and disassembling of the paper container 3 can easily be performed. Still furthermore, since the escape of the hinge pins 30a and 30b from the center holes 19a and 29a of the bearing portions 11a, 11b, 21a and 21b is prevented by the stoppers 12a, 12b, 62a and 62b, it possible to form the hinge pin 30a and 30b as cylindrical shape, simply. Thus, the cost of the hinge structure and the printer 1 using the same can be reduced.

The present invention is not limited to the above-mentioned description and illustration of the embodiment, and it is possible to modify to various manners. The shape of the stoppers 12a and 12b are not limited to have substantially L-shaped section or not limited to have a front free end. If the stopper 12a and 12b is deformable and recoverable by elasticity, the stoppers 12a and 12b can have an arbitrary shape. Furthermore, the stoppers 12a and 12b can directly be formed on the base member 10 without using the holder 13. Still furthermore, the guide face 40a is not necessarily formed at the front end 122 of the stoppers 12a and 12b. In case of forming the guide face 40, the shape of the guide face 40 is not limited to the circular. If the hinge pin 30a or 30b can be held, the guide face 40 can have an arbitrary shape.

Still furthermore, since the hinge structure is not limited to the paper container of the printer, it is applicable to any type of container having a cover member rotatably pivoted on a base member via at least one hinge structure. Still furthermore, the paper container is not limited to a type of containing a roll of the paper. It is possible to apply a paper container for containing bundle of cut sheets. Still furthermore, the kind of the paper contained in the paper container is not limited to the thermal recording paper. For example, when the printer is an inkjet type one for emitting ink on a paper sheet, natural paper can be contained in the paper container.

In summary, it is sufficient that a hinge structure of a container for rotatably pivoting a cover member on a base member comprises the following elements: at least a first bearing portion formed on the cover member and having a first center hole; at least a second bearing portion formed on the base member and having a second center hole of substantially the same diameter of the first center hole; a hinge pin inserted into the first center hole of the first bearing portion and the second center hole of the second bearing portion for aligning said at least a first bearing portion and said at least a second bearing portion on a same axis so that the cover member is rotatably pivoted on the base member; a first stopper formed at a first position on the base member or the cover member for facing an end of the hinge pin with a predetermined gap; and a second stopper formed at a second position on the base member or the cover member so that a part of the second stopper faces another end of the hinge pin with a predetermined gap in a natural shape, and having elasticity to be deformed when the hinge pin is inserted into the first center hole of the first bearing portion and the second center hole of the second bearing portion by applying a pressure thereto and to be recovered to the natural shape when the pressure is released so as to prevent escape of the hinge pin from the first center hole of the first bearing portion and the second center hole of the second bearing portion.

Furthermore, it is sufficient that the printer comprises a paper container for containing a recording paper, a paper feeding mechanism for feeding the recording paper along a predetermined path, a recording head provided at a position facing the predetermined path and for forming an image on the recording paper, and a housing for containing the paper feeding mechanism and the recording head and on which the paper container is held. The paper container has a base member mounted on the housing and a cover member rotatably pivoted on the base member via an at least a hinge structure mentioned above.

By such configurations, when the hinge pin is once inserted into the first center hole of the first bearing portion and the second center hole of the second center hole, the first and second stoppers face both ends of the hinge pin with predetermined gaps. Since the hinge pin can move only in the gaps in axial direction thereof, it is possible to prevent the escape of the hinge pin from the first and second center holes.

This application is based on Japanese patent application 2004-181323 filed Jun. 18, 2004 in Japan, the contents of which are hereby incorporated by references.

Although the present invention has been fully described by way of example with reference to the accompanying drawings, it is to be understood that various changes and modifications will be apparent to those skilled in the art. Therefore, unless otherwise such changes and modifications depart from the scope of the present invention, they should be construed as being included therein.

1. A hinge structure of a container for rotatably pivoting a cover member on a base member comprising:
at least a first bearing portion formed on the cover member and having a first center hole;
at least a second bearing portion formed on the base member and having a second center hole of substantially the same diameter of the first center hole;
a hinge pin inserted into the first center hole of the first bearing portion and the second center hole of the second bearing portion for aligning said at least a first bearing portion and said at least a second bearing portion on a same axis so that the cover member is rotatably pivoted on the base member
a first stopper formed at a first position on the base member or the cover member for facing an end of the hinge pin with a predetermined gap; and
a second stopper formed at a second position on the base member or the cover member so that a part of the second stopper faces another end of the hinge pin with a predetermined gap in a natural shape, and having elasticity to be deformed when the hinge pin is inserted into the first center hole of the first bearing portion and the second center hole of the second bearing portion by applying a pressure thereto and to be recovered to the natural shape when the pressure is released so as to prevent escape of the hinge pin from the first center hole of the first bearing portion and the second center hole of the second bearing portion.

2. The hinge structure in accordance with claim 1, wherein the second stopper serves as a plate spring integrally formed with the first member or the second member.

3. The hinge structure in accordance with claim 1, wherein a guide face for guiding insertion of the hinge pin into the first center hole of the first bearing portion and the second center hole of the second bearing portion is formed near to a front end of the second stopper.

4. The hinge structure in accordance with claim 3, wherein
the hinge pin has a circular cylinder shape, and at least a part of the guide face is circularly bent.

5. A printer comprising a paper container for containing a recording paper, a paper feeding mechanism for feeding the recording paper along a predetermined path, a recording head provided at a position facing the predetermined path and for forming an image on the recording paper, and a housing for containing the paper feeding mechanism and the recording head and on which the paper container is held; wherein
the paper container has a base member mounted on the housing and a cover member rotatably pivoted on the base member via a at least a hinge structure; and
the hinge structure having:
at least a first bearing portion formed on the cover member and having a first center hole;
at least a second bearing portion formed on the base member and having a second center hole of substantially the same diameter of the first center hole;
a hinge pin inserted into the first center hole of the first bearing portion and the second center hole of the second bearing portion for aligning said at least a first bearing portion and said at least a second bearing portion on a same axis so that the cover member is rotatably pivoted on the base member;
a first stopper formed at a first position on the base member or the cover member for facing an end of the hinge pin with a predetermined gap; and
a second stopper formed at a second position on the base member or the cover member so that a part of the second stopper faces another end of the hinge pin with a predetermined gap in a natural shape, and having elasticity to be deformed when the hinge pin is inserted into the first center hole of the first bearing portion and the second center hole of the second bearing portion by applying a pressure thereto and to be recovered to the natural shape when the pressure is released so as to prevent escape of the hinge pin from the first center hole of the first bearing portion and the second center hole of the second bearing portion.

6. The printer in accordance with claim 5, wherein
the second stopper server as a plate spring integrally formed with the cover member or the base member.

7. The printer in accordance with claim 5, wherein
a guide face for guiding insertion of the hinge pin into the first center hole of the first bearing portion and the second center hole of the second bearing portion is formed near to a front end of the second stopper.

8. The printer in accordance with claim 7, wherein
the hinge pin has a circular cylinder shape, and at least a part of the guide face is circularly bent.

9. The printer in accordance claim 5, wherein
the recording paper is a color thermal recording paper and contained in the paper container as a roll.

10. The printer in accordance with claim 9, wherein
the paper container is airtight.
